(19) United States
(12) Patent Application Publication
(10) Pub. No.: US 2019/0251303 A1
(43) Pub. Date: Aug. 15, 2019

(54) INTEGRATED MULTI-PURPOSE SCANNER AND READER.

(71) Applicant: Darrell Fertakos, Lake Hiawatha, NJ (US)

(72) Inventor: Darrell Fertakos, Lake Hiawatha, NJ (US)

(21) Appl. No.: 15/896,264

(22) Filed: Feb. 14, 2018

(51) Int. Cl. G06K 7/08

(52) U.S. Cl. CPC G06K 7/087; H04N 21/4185

(57) ABSTRACT

An integrated multi-purpose reader and processor for mobile device is disclosed. The device includes a plurality of data processing engines namely, cash, driver's license, ID metal detector, finger print and business card scanner, which use UV (ultra violet) or attached stylus, optical character recognition technology and Ink readers to enable portable miniaturized mobile processing of “any form” payments plus document, signature, ID and counterfeit verifications.

This application claims the benefit to U.S. Provisional Application No. 60/601,025, filed on Aug. 13, 2004, and U.S. Provisional Application No. 62/284,001, filed on Sep. 17, 2015, which applications are incorporated herein by reference as if set forth in its entireties.

### FIELD OF THE INVENTION

The present invention relates generally to the field of Information and Communication Technology (ICT) and more particularly to the use of a smart device as an integrated multi-purpose processor.

### BACKGROUND OF THE INVENTION

The Internet of Things (IoT) is the internetworking of physical devices and connected devices namely, smart devices, buildings, homes, parking meters, light bulbs, cars, and other objects embedded with electronics, firmware/software, sensors, actuators and network connectivity that enable these items to collect and exchange data. The IoT allows objects to be sensed and/or controlled remotely across existing network infrastructure creating opportunities for more direct integration of the physical world into computer-based systems, and resulting in improved efficiency, accuracy and economic benefit. When IoT is augmented with sensors and actuators, the technology becomes an instance of the more general class of cyber-physical systems, which also encompasses technologies such as smart grids, smart homes, intelligent transportation and smart cities. Each device is uniquely identifiable through its embedded computing system, but is able to interoperate within the existing Internet infrastructure.

### SUMMARY OF THE INVENTION

Various embodiments provide an integrated multi-purpose scanner and reader for mobile devices comprising a plurality of data processing engines namely, cash, driver's license, ID metal detector, finger print and business card scanner, which use UV (Ultra Violet) or an attached stylus, optical character recognition technology and Ink readers to enable portable miniaturized mobile processing of payments of “any form” in addition to optional document, signature, ID and counterfeit verifications, UPC (Universal Product Code) and QR scanner, photo to fax and photo to digital receipt built within the multi-purpose scanner. Moreover, the present embodiments enable wired and wireless processing of gift card and magnetic strip credit cards including EMV (Europay, Mastercard and Visa) chip cards & cards with RFID (Radio-frequency identification), near field communication and embedded Wi-Fi technologies. In addition, the present embodiments enable scanning, counting, uploading, signature identification and document verification including counterfeit verification, processing of international and local checks via a device attached to or integrated into the design of mobile communication devices such as smart watch, smart device, mobile phone, smart TV remote control, tablet, laptop, PC, a blue tooth credit card paired with a scanner and used with landline phones. Additionally, a cell phone case or an apparatus attached to mobile devices can enable the disclosed embodiments to perform the above articulated functions.

One embodiment provides an integrated multi-purpose reader and processor for mobile devices system. The system comprises a computing architecture having a central processing engine communicatively coupled to one or more data processing engines, said computing architecture configured to exchange information with one or more connected devices; and

a non-transitory computer readable medium having stored thereon instructions that, upon execution by the central processing engine, cause the central processing engine to execute one or more applications associated with the one or more data processing engines, thereby enabling the exchange of a plurality of data points for use in computing the respective transaction communicated by the one or more data processing engines and updating the one or more corresponding applications,

wherein the integrated multi-purpose reader and processor system broadcasts or advertises its digital footprint as comprising a composite of the one or more functionalities associated with the one or more data processing engines.

### BRIEF DESCRIPTION OF THE DRAWINGS

The teachings of the present invention can be readily understood by considering the following detailed description in conjunction with the accompanying drawings, in which:

FIG. 1 depicts a high-level block diagram of a system benefiting from embodiments of the present invention;

FIG. 2 depicts a high-level block diagram of a computing architecture benefiting from embodiments of the present invention;

FIG. 3 depicts an exemplary computing device suitable for use in the system depicted in FIG. 2;

FIG. 4 depicts an exemplary hollow reader benefiting from embodiments of the present invention;

FIG. 5 depicts an exemplary smart watch benefiting from embodiments of the present invention;

FIG. 6 depicts an exemplary smart remote control benefiting from embodiments of the present invention; and

FIG. 7 depicts a Flow Chart of a process for implementing the algorithm according to an embodiment of the invention.

To facilitate understanding, identical reference numerals have been used to designate elements having substantially the same or similar structure and/or substantially the same or similar function.

### DETAILED DESCRIPTION OF THE INVENTION

Various embodiments provide an integrated multi-purpose reader and processor system for mobile devices, which enables scanning and processing f financial transactions. The disclosed system is also designed to validate ID's, driver's licenses, passports, Social Security Number (SSN), credit cards, and authenticate cash and checks. The disclosed system is able to read magnetic head of credit & gift cards or chip cards, read routing or account info of checks and ink codes to thereby process all paper, digital and international checks. Stated differently, the disclosed system is able to take photos of checks in order to accept and process same, to count cash via a scanning process that facilitates the reading of serial numbers or the denomination of the cash currency or by using optical character recognition technology to authenticate and process a check, cash and IDs. The disclosed reader and processor system for mobile devices can determine counterfeit money from currencies originated from all over the world via the currency “visual check search engine” and use of UV or ink checking technologies. The disclosed reader and processor system for mobile devices also enables the scanning of business cards to upload the data enabling edits. The contact info from business cards is uploaded into the contact list on the cell phone, house phone or desktop app. The credit card reader embodiment provides for a connection to a land-line (house) phone such that during calls to operators or companies requesting that the consumer repeats credit card info out loud over the phone, one could simply swipe their credit card reader attached to their house or cell phone to enable credit card processing via screen sharing or data sharing over land or wireless lines.

The disclosed embodiments further provide a multi-purpose scanner, which may be built into a smart device, a smart watch, TV remote device, PC mouse, keyboard, smart bracelet, smart glasses or contact lenses. The multi-purpose scanner is attached to these devices via USB ports or Wi-Fi, Bluetooth, house phone, by phone jack/DSL or the multipurpose scanner can communicate wirelessly with some house phones having this capability-to enable credit card processing over the phone without sharing credit card info to others. There are numerous ways to accomplish this task namely, (1) simply swipe the card while on the phone with the disclosed reader such that payment is effected over the phone; (2) thru a TV with the card reader attached to the disclosed scanner/reader built into the TV's remote control; or (3) connect to the cable box, DVR, DVD player with connection over Wi-Fi or via IR (Infra-Red). The disclosed scanner incorporates an encoding/decoding engine to ensure transactions are encrypted and secure. Additionally, one is only able to receive from those allowed into one's network to enable payment.

The illustrative reader and processor system for mobile devices embodiments described herein is not meant to be limiting. It may be readily understood that certain aspects of the disclosed reader and processor system for mobile devices can be arranged and combined in a variety of different configurations, all of which are contemplated herein.

Generally speaking, any computing device such as a cellular telephone or smart phone or any computing device having similar functionality may implement the various embodiments described herein. In various embodiments, any Internet enabled device such as personal digital assistant (PDA), laptop, desktop, electronic book, tablets and the like capable of accessing the Internet may implement the various embodiments described herein. While computing devices are generally discussed within the context of the description, the use of any device having similar functionality is considered to be within the scope of the present embodiments.

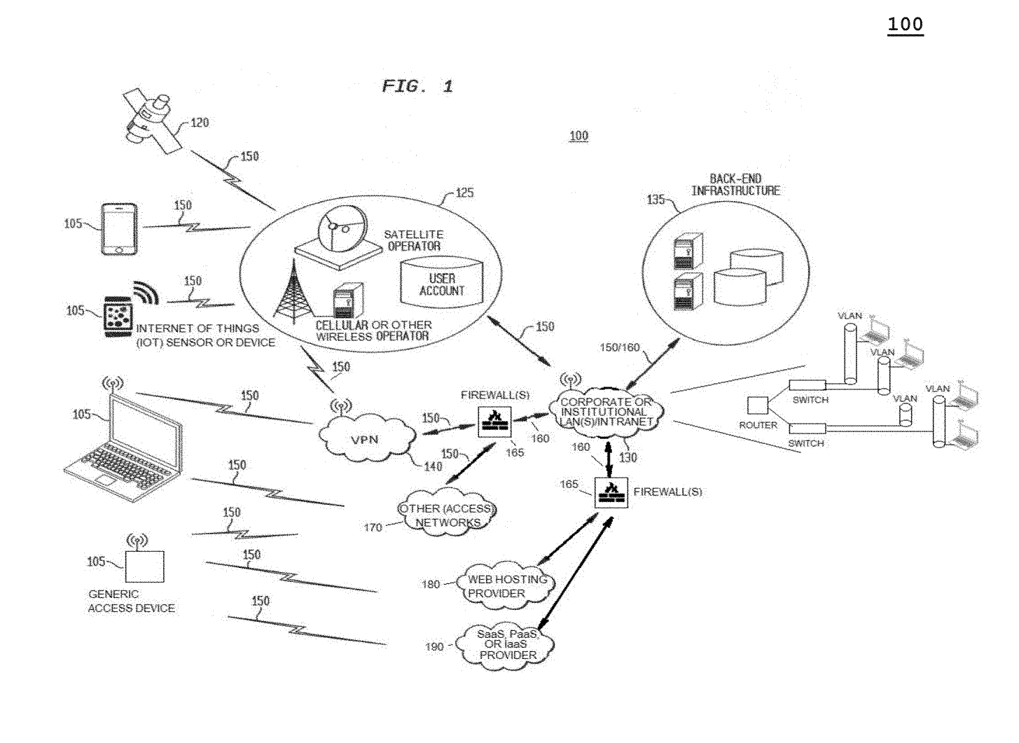

Referring now to the figures, FIG. 1 is a simplified block diagram of a reader and processor system for mobile devices 100, according to an exemplary embodiment herein described.

In one embodiment, the user interacts with networks 120, 125, 135, 130, 140, 170, 180, 190 via link 150/160. In one embodiment, link 150 extends over great distance and is a cable, satellite or fiber optic link, the Internet, the Cloud, a combination of such links or any other suitable communications path. In various embodiments, link 150 extends over a short distance. In one embodiment, link 150 is a network connection between geographically distributed systems, including network connection over the Internet. In other embodiments, link 150 is wireless, an access network, a virtual private network.

In various embodiments, device 105 is a smart phone, cellular telephone, personal digital assistant (PDA), wireless hotspot or any Internet-enabled device including a desktop computer, laptop computer, tablet computer, smart watch 500, smart remote control 600, smart credit card, IoT (Internet of Things) sensor, IoMT (Internet of Medical Things) sensor) and the like capable of accessing the Internet may be used for device 105.

In various embodiments, Satellite 120 is a geo-synchronous satellite system such as global positioning system (GPS). In one embodiment, satellite 120 is low earth orbit satellite system. In other embodiments, the use of any system having similar functionality is considered to be within the scope of the present embodiments.

In various embodiments, cellular system 125 is a wireless infrastructure supporting cellular network functionality. In one embodiment, cellular system 125 is a small area wireless system. In other embodiments, cellular system 125 is a wide area wireless system. In other embodiments, cellular system 125 is a Wi-Fi system. In various embodiments, cellular system 125 supports mobile services within an LTE (Long Term Evolution) network or portions thereof, those skilled in the art and informed by the teachings herein will realize that the various embodiments are also applicable to wireless resources associated with other types of wireless networks (e.g., 5G networks, 4G networks, 3G networks, 2G networks, WiMAX, CDMA, GSM, etc.), wireline networks or combinations of wireless and wireline networks. Thus, the network elements, links, connectors, sites and other objects representing mobile services may identify network elements associated with other types of wireless and wireline networks. In other embodiments, the use of any wireless system having similar functionality is considered to be within the scope of the present embodiments.

In various embodiments, network 130 is an access network. In one embodiment, network 140 is a virtual private network (VPN). In other embodiments, network 130 is any network having similar functionality and as such is considered to be within the scope of the present embodiments.

Backend infrastructure 135 generally refers to infrastructure associated with the server or host, a web server. In other embodiments, networking system 100 include additional, fewer, or different modules for various applications. Conventional components such as network interfaces, security functions, load balancers, failover servers, management and network operations consoles, and the like are not shown for better explanation of the details of the reader and processor system for mobile devices.

Web hosting provider 180 refers to the universe of hosting services, e.g., smaller hosting services, larger hosting services and host management.

Saas (Software as a service), PaaS (Platform as a service) or IaaS (Infrastructure as a service) provider 190 refers to cloud services, hosting and the like.

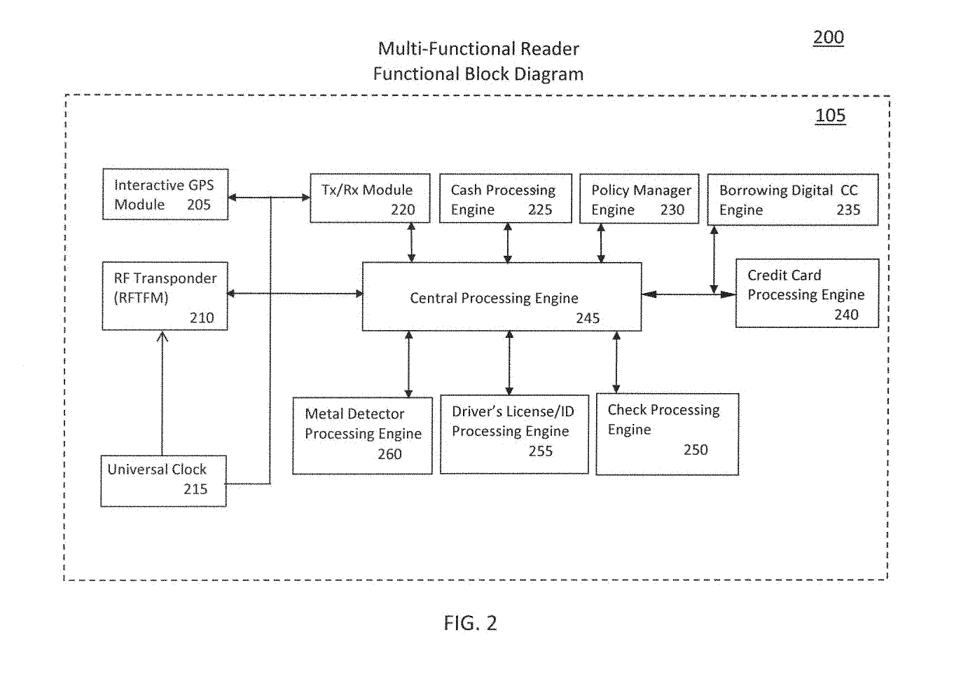

FIG. 2 depicts a high-level block diagram of a computing architecture benefiting from embodiments of the present invention. In one embodiment, computing architecture 200 comprises an interactive GPS module 205, which interfaces to the GPS (Global Positioning Satellite) network. GPS works by GPS receivers using a constellation of satellites and ground stations to compute position and time almost anywhere on earth. There are ground based stations that communicate with the satellite network and are called the control segment. Common systems that are used by the control segment are WAAS (Wide Area Augmentation System) and DGPS (Differential Global Positioning Satellite). WAAS is the most common system and improves accuracy to about five (5) meters. On the other hand, DGPS gets centimeter accuracy, but is very expensive. GPS data is displayed in different message formats and the type of data that is outputted is NMEA (National Marine Electronics Association) data. In one embodiment, the GPS portion of device 200 can track up to twenty two (22) satellites on sixty six (66) channels. An external UFL antenna or similar device is connected to the GPS module. In another embodiment, interactive GPS module 205 implements an ancillary geographic positioning methodology (for example, a GPS that either has the last location coordinates or has real-time location coordinates).

In one embodiment, computing architecture 200 comprises an RF transponder module (RFTFM) 210, which enables text messages, phone calls, faxes to be completed and/or routed. These functions of computing architecture 200 work through the GSM (Global Packet Radio Service) cellular network and are controlled by AT commands, which are the data transmission that the GPRS module sends. Generally, GPRS works by using the idle radio capacity created by GSM (Global System for Mobile Communications) cellular network, which is the capacity of a network provider that is not being used. A GPRS module sends data transmission through data packets through multiple paths across a GSM network. In other embodiments, RF transponder module (RFTFM) 210 is used to receive handshake or activation signals from external devices. In yet other embodiments, the native system of the device implementing computing architecture 200 is used. In other embodiments, computing architecture 200 comprises any device 105 having similar functionality and as such is considered to be within the scope of the present embodiments.

In one embodiment, computing architecture 200 comprises a Tx/Rx module 220, which is used to format and configure signals to be transmitted and received. In one embodiment, an L-band (or Ku/Ka band) Tx/Rx satellite link transceiver is supported. In yet other embodiments, High Throughput Satellite (HTS) services are utilized.

In one embodiment, computing architecture 200 comprises a Universal Clock Module 215, which is used to maintain absolute time, e.g., time of day. In other embodiment, Universal Clock Module 215 is used as a synchronizing clock.

In one embodiment, computing architecture 200 comprises a Cash Processing Engine 225, which is used to count any currency, read the serial number and check for counterfeit. Cash Processing Engine 225 utilizes the multi-purpose functionality of computing architecture 200 to perform some of its functions. In one embodiment, Cash Processing Engine 225 uses Ink technology to read paper money, project UV light on a note (paper money) under inspection to authenticate the note thereby determining if the note is counterfeit. In other embodiments, a hollow reader 400 is implemented allowing for both sides of the note, check, business card or ID to be scanned simultaneously in order to authenticate, count or process same. In other embodiments, the disclosed computer architecture is interfaced to a cash register in performing these functions. In other embodiments, the cash register has Infra-Red (IR) interface to communicate with computing architecture 200 enabling one or more individuals to send UPC (Universal Product Code)of products they wish to purchase or credit card information from many feet away thereby reducing waiting lines at retail stores.

In one embodiment, computing architecture 200 comprises a Policy Manager Engine, which houses various operational parameters, scripts, modalities and the policies that central Processing Engine adheres to under certain circumstances. For example, Policy Manager Engine 230 provides policies and directives for: (1) the communication protocol and handshake for all the devices computing architecture 200 interfaces to; (2) the policy implemented when authenticating a specific currency; (3) the policy implemented when credit card information and/or other private information is communicated; and (4) the conditions under which an emergency alarm is produced e.g., upon scan of counterfeit money, fake ID, fake check, or credit card a GPS signal location is available to authorities, website or to local police that gets notification of the location, and under those circumstances a miniaturized camera size is activated to capture a silent picture of the surrounding environment. In one embodiment, the camera is a high resolution low light improved camera with capability of improved low light picture taking, night vision and infrared thermography options integrated or attached to future designs to check for stolen properties and goods, powered by separate battery not to drain current battery within mobile phones. In other embodiment, the camera utilizes the same battery.

In other embodiment, policies are downloaded in real-time. The policy manager can also define the length of time or time-window a particular transmission mode is used or the sequence of the various modes to be used over time. In another embodiment, a one-time pre-configured set of operational policies is “burnt” into the device.

In one embodiment, computing architecture 200 comprises a Borrowing Digital Credit Card Engine 235, which enables an individual to send credit card information to authorize others to use the credit card for a period of time such that an individual can make payment for any purpose. The digital picture of the card is sent to a phone, tablet, or mobile device. The vendor then verifies the picture and the borrowed card notification. The vendor scans the picture or takes a photo and the “Borrowed Card Works” enables one without any plastic or credit cards to suddenly be able to use another's credit card. The card is borrowed by express and explicit authority of the owner, such as a boss, parents, state agency, etc. whereas available restrictions for use can be set, including amount spent, and even GPS tracking. In other embodiment, the condition specifies a certain place or location or a specific store.

In one embodiment, computing architecture 200 comprises a Credit Card Processing Engine 240, which enables vendor communication between unit users, bidding platform for lowest percent (%) rate for merchant and credit card processing with API (Application Programming Interface) integration and web crawling technologies to find lowest transaction rate. A vendor and company “mutually agree” to accept a “special low % rate” per transaction or time duration. The disclosed device communicates with other device users to promote business, products and process sales or transactions.

In one embodiment, the credit card itself has a digital interface and numbers on the card can change every day, week, month or by transaction to reduce identity theft. In other embodiment, numbers on the card disappear: (1) once the fingerprints of the user are removed, (2) by a certain time sets by the user for the numbers to change, (3) by heat removed from the card. In other embodiment, the card is equipped with a touch screen interface in which case the numbers become non-visible upon command. In other embodiments, a smart card also has a built-in reader to process credit card payments and check.

In one embodiment, computing architecture 200 comprises Central Processing Engine 245, which is a logical decision entity of much computational complexity. Central Processing Engine 245 manages the operations of the device. In one embodiment, Central Processing Engine 245 incorporates a real-time, multi-tasking computing entity, which executes host functions, middleware suite and operational utility host suite for the maximization and optimization of operational utility of the device. Central Processing Engine 245 collects information such as parameters, data points, coded voice, coded video, location coordinates and other signals.

In one embodiment, computing architecture 200 comprises Check Processing Engine 250, which is used to process different checks such as personal check, travelers' check, and international check. The check is authenticated using the multi-purpose scanning functionality of computing architecture 200.

In one embodiment, computing architecture 200 comprises ID Processing Engine 255, which utilizes the multi-purpose scan functionality of the disclosed device to verify the authenticity of any ID such as passport, social security, driver's license, military ID and the like. In some embodiments, ID Processing Engine 255 works in conjunction with a fingerprint processing engine (not shown), Iris Processing Engine (not shown) to verify the authenticity of any ID.

In one embodiment, computing architecture 200 comprises Metal Detector Engine 260, which utilizes the multi-purpose scan functionality of the disclosed device to scan clients at clubs, bars, events and the like. In one embodiment, thermal imaging is used.

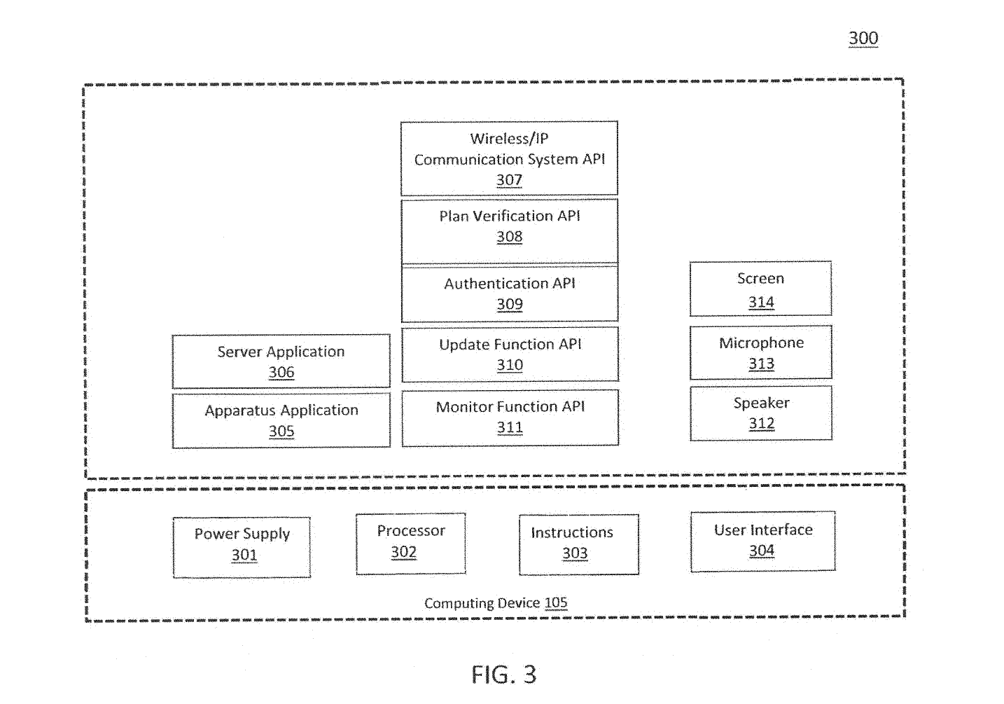

FIG. 3 depicts an exemplary computing device suitable for use in the architecture depicted in FIG. 2. Computing device 105 may include power supplies 301, a processor 302, and a memory 303 for storing instructions and the like, a user interface 304. Power supply 301 provides power to computing device 105. As such, the power supply may include, for example backup batteries. Other power supply configurations are possible as well. Processor 302 included in computing devices 105 may comprise one or more general-purpose processors and/or one or more special-purpose processors (e.g., image processor, digital signal processor, vector processor, etc.). To the extent that computing device 105 includes more than one processor, such processors could work separately or in combination. Computing device 105 may be configured to control functions of reader and processor for mobile devices system 100 based on input received from one or more clients via user interface 304, for example.

Memory 303 may comprise one or more volatile and/or nonvolatile storage components such as optical, magnetic, and/or organic storage and memory 303 may be integrated in whole or in part with computing device 105. Memory 303 may contain instructions (e.g., applications programming interface, configuration data) executed by processor 302 in performing various functions of reader and processor for mobile devices system 100, including any of the functions or methods described herein. Memory 303 may further include instructions executable by processor 302 to control and/or communicate with the additional components.

Peripherals may include speaker 314, microphone 313 and screen 316. Speaker 314 may be configured to output audio to the user of reader and processor system for mobile devices 100.

Similarly microphone 315 may be configured to receive audio from a user of reader and processor for mobile devices system 100. Screen 316 may comprise one or more devices used for displaying information to the user of computing device 105. Screen 316 may comprise a touchscreen used by a user to input commands to computing device 105. As such, a touchscreen may be configured to sense at least one of a position in the movement of a user's finger via capacitive sensing, or a surface acoustic wave process among other possibilities. Generally, a touchscreen may be capable of sensing finger movement in a direction parallel or perpendicular to the touchscreen surface or both, and may also be capable of sensing a level of pressure applied to the touchscreen surface. A touchscreen comes in different shapes and forms.

Computing device 105 may include one or more elements in addition to or instead of those shown.

In various embodiments, APIs are used for transferring data from Server application 306 to Apparatus application 305. Although depicted and described with respect to the aforementioned APIs, it will be appreciated by those skilled in the art that other APIs having similar functionality are considered to be within the scope of the present embodiments.

In one embodiment, APIs (308, 309, and 310) are used for passing Email and password parameters from Apparatus application 305 to Server application 306 and used to validate the login of the user.

In one embodiment, APIs (307,308, 309, and 310) transfer Email parameters from Apparatus application 305 to Server application 306 and new password is sent to users email.

Generally speaking, apparatus 105 include any Internet enabled device such as personal digital assistant (PDA), laptop, desktop, electronic book, tablets and the like capable of accessing the Internet may implement the various embodiments described herein. While apparatus 105 is generally discussed within the context of the description, the use of any device having similar functionality is considered to be within the scope of the present embodiments.

Although depicted and described with respect to an embodiment in which each of the APIs, engines, databases, and tools is stored within memory 303, it will be appreciated by those skilled in the art that the APIs, engines, database, and/or tools may be stored in one or more other storage devices internal to computing device 105.

The APIs, engines and tools may be activated in any suitable manner. In one embodiment, for example, the APIs, engines and tools may be activated in response to manual requests initiated by a user, in response to automated requests initiated by computing device 105, or other devices and the like, as well as various combinations thereof. For example, where an engine or tool is activated automatically, the engine or tool may be activated in response to scheduled requests, in response to requests initiated by computing device 105 based on processing performed at computing device 105.

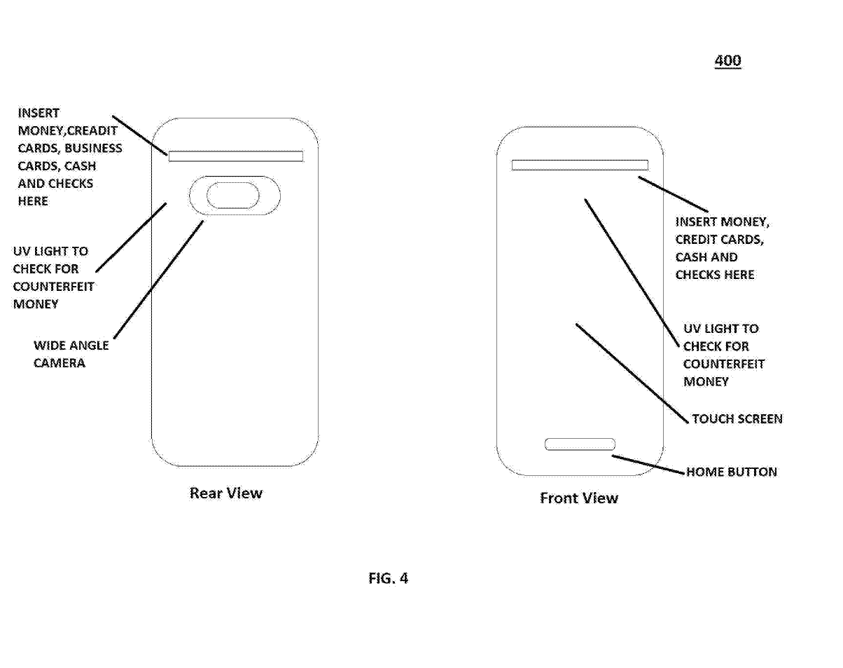

FIG. 4 depicts an exemplary hollow reader benefiting from embodiments of the present invention. In one embodiment, the hollow reader incorporates a slot at one end of the device. The slot or aperture is used to slide notes (paper money), credit card, business cards, cash and checks to be processed. Hollow reader 400 is implemented allowing for both sides of a note (paper money), check, business card or ID card to be scanned simultaneously in order to authenticate, count or process same. Additionally, the device is equipped with a wide angle camera.

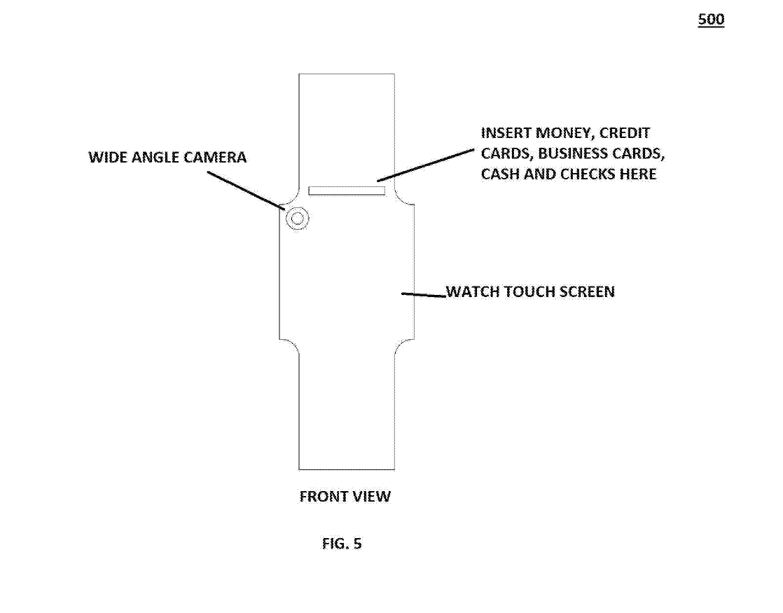

FIG. 5 depicts an exemplary smart watch benefiting from embodiments of the present invention. As shown, the watch incorporates a slot at one end of the device. The slot or aperture is used to slide money, credit card, business cards, cash and checks to be processed as previously discussed. Additionally, the device is equipped with a wide angle camera.

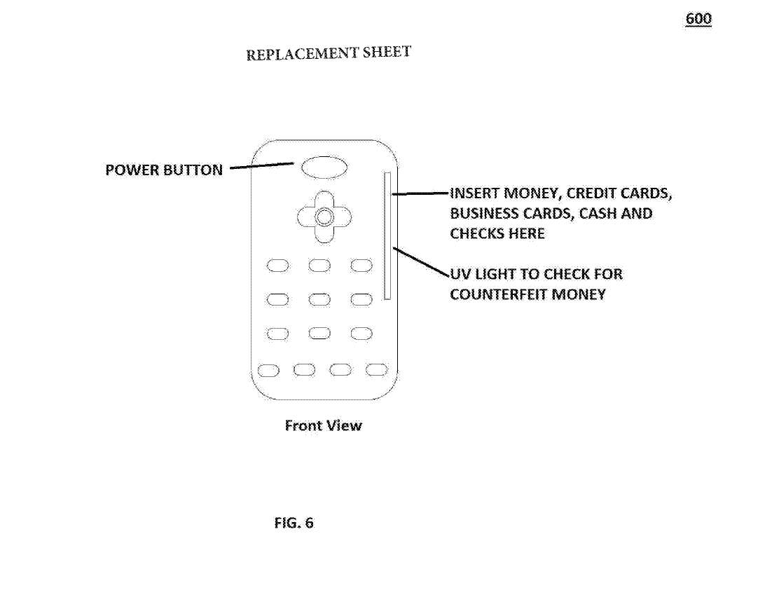

FIG. 6 depicts an exemplary smart remote control benefiting from embodiments of the present invention. As discussed above, the smart remote incorporates a slot on one side of the device. The slot or aperture is used to slide notes (paper money), credit card, business cards, cash and checks to be processed as discussed above.

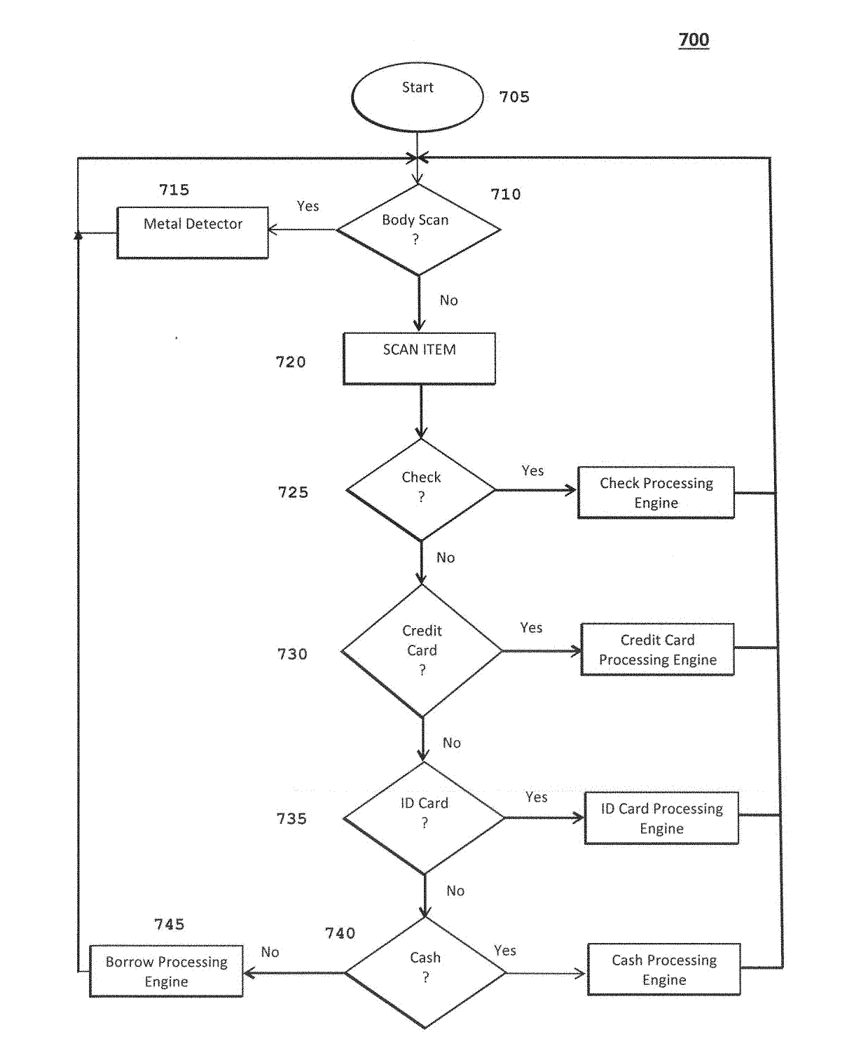

FIG. 7 depicts a Flow Chart of a process for implementing the algorithm according to an embodiment of the invention.

At step 705, a user accesses the reader and processor system for mobile devices; the user is identified using fingerprint recognition, iris recognition, facial recognition or password and authenticated. Upon positive authentication, the process continues to the next step. Otherwise, the user is rejected and the process starts over.

At step 710, the body scan function is executed to determine the type of scan to perform. If yes, Metal Detector Processing Engine 260 is activated; otherwise step 720 is executed. Metal Detector Processing Engine 260 is described above in reference to FIG. 2.

At step 720, the item is scanned. For example, the item may be a check, a credit card, an ID card or a note.

At step 725, if it's determined to be a check then Check Processing Engine 250 described above in reference to FIG. 2 is activated. At the end of the operation, the process loops back to the beginning. If no, step 730 is executed.

At step 730, if it's determined to be a credit card then Credit Card Processing Engine 240 described above in reference to FIG. 2 is activated. At the end of the operation, the process loops back to the beginning. If no, step 735 is executed.

At step 735, if it's determined to be an ID card, driver's license, passport, social security card, military ID then ID Processing Engine 255 described above in reference to FIG. 2 is activated. At the end of the operation, the process loops back to the beginning. If no, step 740 is executed.

At step 740, if it's determined to be a note, then Cash Processing Engine 225 described above in reference to FIG. 2 is activated. Cash Processing Engine 225 supports various functions as described above. At the end of the operation, the process loops back to the beginning. If no, step 745 is executed.

At step 745, Borrowing Digital Credit Card Processing Engine 235 is activated if a credit card is borrowed from the authorized user. Otherwise, the process loops back to step 705.

The foregoing description of the embodiments of the invention has been presented for the purpose of illustration; it is not intended to be exhaustive or to limit the invention to the precise forms disclosed. Persons skilled in the relevant art can appreciate that many modifications and variations are possible in light of the above disclosure. For example, in one mode of operation a menu of options is presented to the user to choose from. In such case, the execution of the steps is performed simultaneously or concurrently also known as multitasking. In one embodiment, parallel computing is used.

Some portions of this description describe the embodiments of the invention in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments of the invention may also relate to a product that is produced by a computing process described herein. Such a product may comprise information resulting from a computing process, where the information is stored on a non-transitory, tangible computer readable storage medium and may include any embodiment of a computer program product or other data combination described herein.

Finally, the language used in the specification has been principally selected for readability and instructional purposes, and it may not have been selected to delineate or circumscribe the inventive subject matter. It is therefore, intended that the scope of the invention be limited not by this detailed description, but rather by any claims that issue on an application based hereon.

Although various embodiments, which incorporate the teachings of the present invention have been shown and described in detail herein, those skilled in the art can readily devise many other varied embodiments that still incorporate these teachings.

1. An integrated multi-purpose reader and processor for mobile devices, comprising:
a computing architecture having a central processing engine communicatively coupled to one or more data processing engines, said computing architecture configured to exchange information with one or more connected devices; and
a non-transitory computer readable medium having stored thereon instructions that, upon execution by the central processing engine, cause the central processing engine to execute one or more applications associated with the one or more data processing engines thereby enabling the exchange of a plurality of data points for use in computing the respective transaction communicated by the one or more data processing engines and updating the one or more corresponding applications,
wherein the integrated multi-purpose processor broadcasts, advertises its digital footprint as comprising a composite of the one or more functionalities associated with the one or more data processing engines.

2. The integrated multi-purpose reader and processor for mobile devices of claim 1, wherein the computing architecture comprises a server or host communicatively coupled to the cloud, said server propagates configuration data towards the central processing unit, thereby enabling said at least central processing unit to interact with the plurality of data processing engines to exchange a plurality of data points with at least one data processing engine for use in computing one or more specific functionalities associated with the respective data processing engine.

3. The integrated multi-purpose reader and processor for mobile devices of claim 2, wherein the cloud comprises a social network, a virtual private network (VPN), a wide area network (WAN), a local area network (LAN), corporate LAN, the Internet, satellite communication network, cellular network, Internet of Things (IoT), Internet of Medical Things (IoMT).

4. The integrated multi-purpose reader and processor for mobile devices of claim 1, wherein the data processing engines comprise one of metal detector processing engine, driver's license processing engine, ID processing engine, personal check processing engine, credit card processing engine, business card processing engine, fingerprint processing engine, Iris processing engine, borrowing of digital credit card processing engine and cash processing engine.

5. The integrated multi-purpose reader and processor for mobile devices of claim 1, wherein the computing architecture comprises a smart device.

6. The integrated multi-purpose reader and processor for mobile devices of claim 1, wherein the one or more data processing comprise an external device.

7. The integrated multi-purpose reader and processor for mobile devices of claim 1, wherein the one or more data processing engines are implemented in hardware.

8. The integrated multi-purpose reader and processor for mobile devices of claim 6, wherein the external device comprises one of set-top box, IoT connected device, IoMT connected device, smart TV and cable box.

9. The integrated multi-purpose reader and processor for mobile devices of claim 1, wherein the computing architecture determines the communication protocol and handshake used.

10. The integrated multi-purpose reader and processor for mobile devices of claim 4, wherein the ID reader is used in conjunction with smart TV via the remote control to process payments.

11. The integrated multi-purpose reader and processor for mobile devices of claim 4, wherein the multipurpose scanner is integrated into the case of the mobile device.

12. The integrated multi-purpose reader and processor for mobile devices of claim 4, wherein the multipurpose scanner attaches to the mobile device.

13. A card reader device for reading a card having data stored on a magnetic stripe incorporated into the card, the device comprising:
a read head for passing a magnetic stripe of a card by to read data stored on a magnetic stripe and for producing a signal indicative of data stored on a magnetic stripe;
a signal setting device for setting an amplitude of the signal indicative of data stored on a magnetic stripe; and
an output jack adapted to be inserted into a microphone input associated with a cell phone for providing the signal indicative of data stored on a magnetic stripe to a cell phone.
